(19) United States
(12) Patent Application Publication
(10) Pub. No.: US 2011/0219516 A1
(43) Pub. Date: Sep. 15, 2011

(54) Two-Part Interchangeable Neckwear

(76) Inventor: William M. Pionessa, Addison, NY (US)

(21) Appl. No.: 12/720,837

(22) Filed: Mar. 10, 2010

(51) Int. Cl. A41D 25/04; A41D 25/02; F16M 11/22; F16M 11/04

(52) U.S. Cl. 2/145; 2/151; 248/440.1; 248/121

(57) ABSTRACT

A necktie having two components—a collar component for fastening around a wearer's neck and a tie component. These two components will be connected with mating portions of hook-and-loop fastener material on the tie portion and on at least one side of the central portion of the collar component in the area where the knot of a conventional necktie would be. The collar and tie components can be made in assorted colors, sizes and patterns, so that a wearer will be able to mix and match the tie components with various collar components.

### BACKGROUND OF THE INVENTION

1. Field of the Invention

The invention pertains to the field of neckwear. More particularly, the invention pertains to neckties having interchangeable portions.

2. Description of Related Art

I came up with the idea of the necktie of the invention while sitting at home watching television, Every man I saw on the News channels, Game and Sports shows, and even the senators and congressmen had ties that were either too tight, too loose, dented, bunched up, and pushed off to the left or right. There was no uniform look, or neatness that showed through. All of the men had great looking shirts and sport coats. However their ties, which should be the focus point of a good looking suit, although well made and very colorful, were not eye appealing, neat, or tidy looking.

My idea is to create a new look that is smooth, neat, uniform, unique, easy to put on, and that gives a quality look to a well made suit.

We also have many young people in school, college, or just starting out in the business world, that would not have to worry about how to tie a tie, or get it to look right after they had tied it. I personally always had trouble getting the front of the tie to be longer than the back.

Lately I've been seeing many men on television just wearing dress shirts with open collars, and a sport coat. I believe this is happening because men, young or old, are losing interest in having to tie a tie each morning, or after tying it how it looks because of dents, unappealing shape, or they are just not uniform looking.

I think employers looking for a new employee are more impressed with a person wearing a sharp looking tie, than someone just wearing an open neck shirt and sport coat. I believe that neatness, uniformity, and quality are a very important part of any sale, whether it's a product, or yourself.

Cole, U.S. Pat. No. 401,690, “Neckscarf”, shows a reversible tie system, in which the depending tie portion has attachment loops at each end, allowing the tie to pass through a simulated knot on the neckband and fasten in place by a button. The tie portion can be reversed or flipped end-for-end, allowing additional wear.

Less, U.S. Pat. No. 1,972,594, “Tie and Method of Making the Same”, shows a tie made up of a number of parts, including a simulated knot, which are permanently sewn together.

Loomis, U.S. Pat. No. 2,874,386, “Necktie”, has a split and adjustable neckband fastening with a buckle, and a simulated knot sewn to a single-layer tie portion.

Chen, U.S. Pat. No. 5,778,453, “Necktie”, shows an interchangeable tie system having a neck strap and a mechanical attachment fixture having springs and catches to which tie portions mechanically attach with clips.

DeLuca, U.S. Pat. No. 6,363,533, “Extended Use-Life Improved Tie” shows a three- or four-piece tie having a rigid “knot” part, one or two impermeable neck straps joined by holes in pins or hook-and-loop material, and a single piece tie which has holes which hook or snap to fittings inside the “knot”.

Paik, US Published Application 2001/0042259, “Necktie” shows a two-part necktie system in which the simulated “knot” part of the tie is rigid and three-dimensional, and a conventional necktie loops over a clip which inserts into the “knot”.

Bostwick, US Published Application 2005/0015845, “Hand-Tied Hook and Loop Necktie” is a conventional tie with a hand-tied knot stitched in place. The neck band of the tie is split and joined by hook-and-loop fastener material.

### SUMMARY OF THE INVENTION

The invention presents a necktie having two components—a collar component for fastening around a wearer's neck and a tie component. These two components will be connected with mating portions of hook-and-loop fastener material on the tie portion and on at least one side of the central portion of the collar component in the area where the knot of a conventional necktie would be. The collar and tie components can be made in assorted colors, sizes and patterns, so that a wearer will be able to mix and match the tie components with various collar components.

A cylindrical holder is also described, which allows storage of a number of the neckties by fastening the collar component of the necktie around the cylinder.

### BRIEF DESCRIPTION OF THE DRAWING

FIG. 1 shows a view of the necktie of the invention with the two components separated.

FIG. 2 shows a view of the necktie of the invention with the two components assembled.

FIG. 3 shows a rear view of the necktie of the invention with the collar component unfastened.

FIG. 4 shows a rear view of the necktie of the invention as in FIG. 3, in an alternative embodiment of the tie component and a pin-and-hole fastener for the collar.

FIG. 5 shows a side view of the necktie of the invention.

FIG. 6 shows a side view of the necktie of the invention in an embodiment having a stuffed central portion.

FIGS. 7a-7c show the necktie of the invention as fastened around a collar, showing how the tie component can be interchanged with different designs.

FIGS. 8a-8g show details of the front part of the invention, in an embodiment having additional ornaments fastening to the front of the collar component.

FIGS. 9-11 show an alternative arrangement of the necktie of the invention, using a bowtie component in place of the tie component shown in previous figures, wherein FIG. 9 shows the collar component of the invention, fastened with the fastener material on the central portion facing outward, FIG. 10 shows a rear view of a bowtie component for use with the necktie of the invention having fastening material on the back, and FIG. 11 shows the necktie of the invention assembled in bowtie configuration.

FIG. 12 shows a front view of a wall-mounted holder for use with neckties of the invention.

FIG. 13 shows a side view of the holder of FIG. 12, having neckties in place on the holder.

FIG. 14 shows a front view of a holder for horizontal surfaces for use with neckties of the invention.

FIG. 15 shows the holder of FIG. 14, having neckties in place on the holder.

### DETAILED DESCRIPTION OF THE INVENTION

One advantage of owning the necktie of the invention is not having to tie a tie every time you get dressed in the morning. You simply connect a tie component and collar component together, pull your shirt collar up, and wrap the collar component straps around your neck, press the fastener together at the point adjusted for your neck, put your shirt collar down, and you are ready for your sport coat.

Another advantage is the consumer can mix and match different tie components with different collar components for a unique look. A third advantage is if your tie gets pulled on hard, or caught in a piece of equipment, it will separate from the collar component. A final advantage is that there is no extra loose end hanging down behind the front part of the tie as in a conventional tie, and so less material is used to produce the necktie of the invention.

### Basic Necktie System

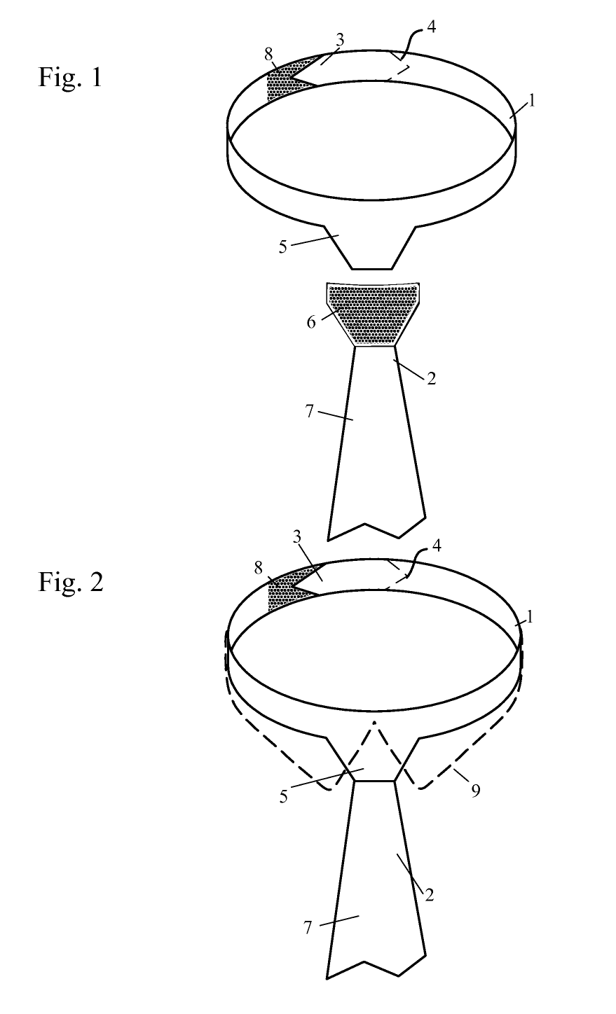

As shown in FIGS. 1 through 6, the necktie of the invention has two parts—a collar component (1) and a tie component (2).

The collar component (1) has an elongated body which fits around a wearer's neck having an enlarged central area (5) where a knot would be in a conventional tie, and free ends (3) and (4), which preferably end in points as shown in the figures. The collar component (1) will fit under the shirt collar (9), with the central area (5) visible, as shown in FIG. 2.

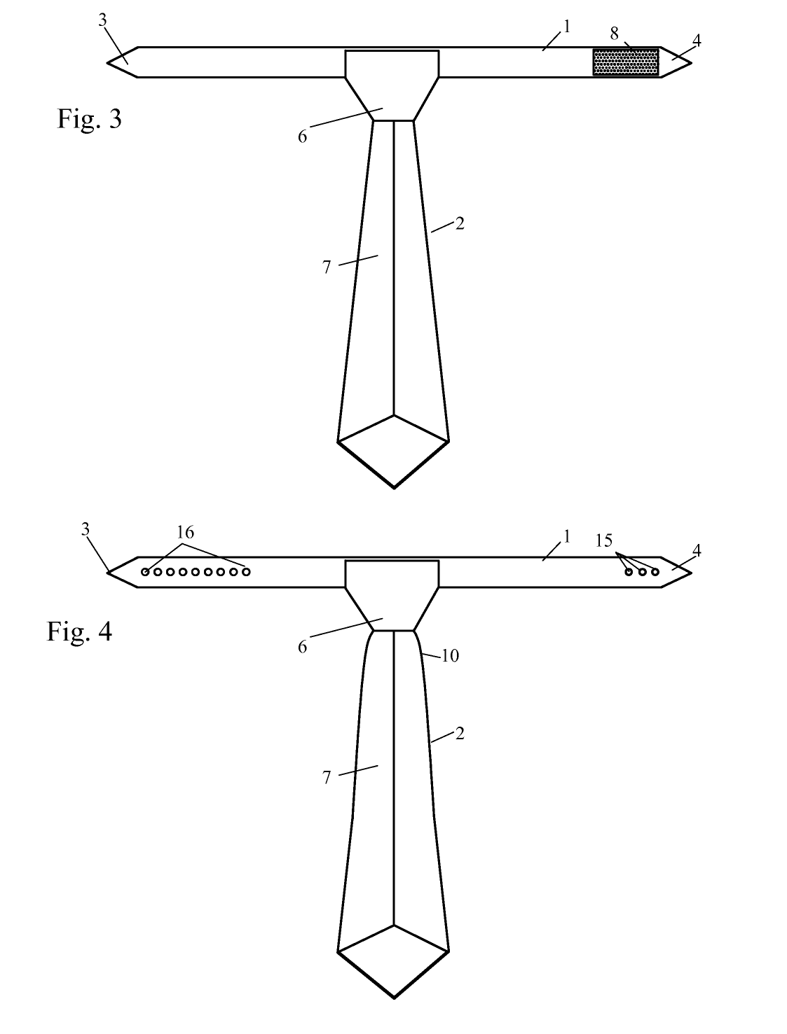

The free ends (3) and (4) have mating fasteners to allow the free ends to be adjustably fastened around a wearer's neck. In FIGS. 1, 2 and 3 this is shown as an area of hook-and-loop fastener material (8) such as Velcro® near the points of the free ends which mate with each other. Preferably, the point at the end of at least one of the free ends (as shown at (4) in FIG. 3) is left without fastener material, providing a finger tab for easy removal of the collar. FIG. 4 shows an alternate embodiment, in which the hook-and-loop fastener is replaced by a pin-and-hole system as is commonly used in adjustable baseball cap headbands, in which pins (15) on end (4) are snapped into holes (16) on end (3). It will be understood that other methods of fastening the collar component around a wearer's neck are possible within the teachings of the invention.

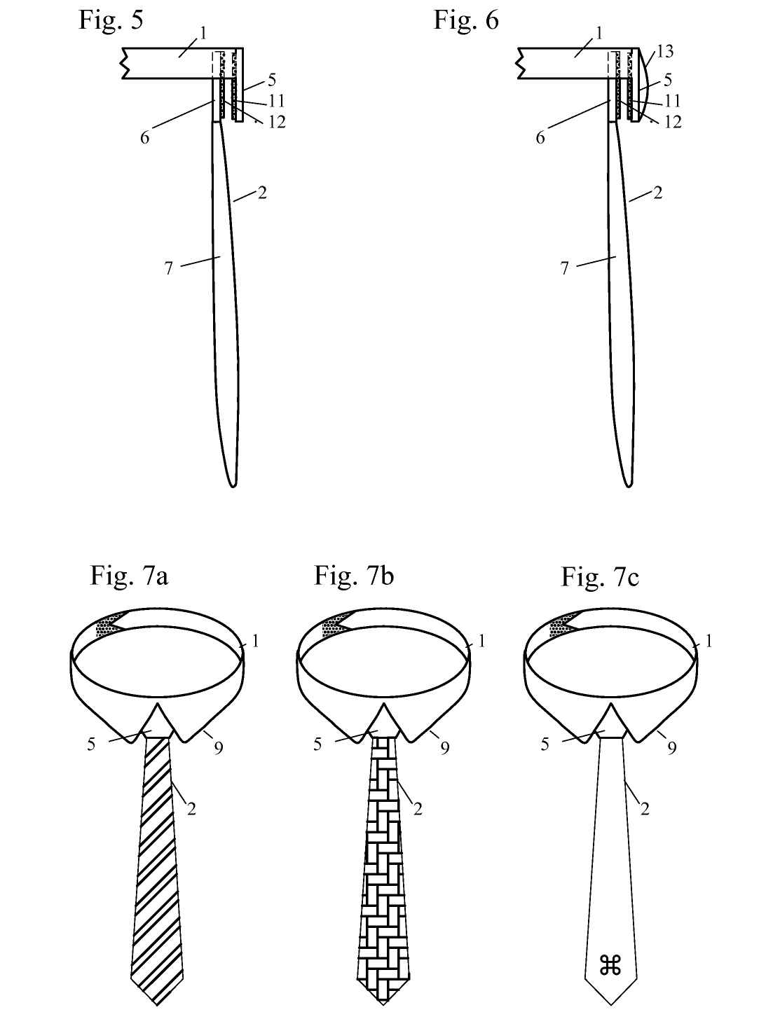

As can be seen in FIGS. 5 and 6, the central area (5) of the collar component (1) has a piece of fastener material (11) on an inner portion, so that when the collar component (1) is worn, the fastener material (11) is not visible. The tie component (2) has an upper portion (6) with matching fastener material (12), and a lower portion (7). The fastener material (12) on the upper portion (6) of the tie component (2) is placed behind material (11) on the central portion (5) of collar component (1), holding the tie component (2) in place with the upper portion (6) concealed behind central portion (5) and the lower portion (7) hanging down to form the tie.

The fastener material (11) and (12) is preferably a hook-and-loop material such as Velcro®, but it will be understood that other separable fastener materials would be equally appropriate. Mating pieces of flat, flexible magnet would be appropriate as fasteners in addition to purely mechanical separable fastener material.

After the tie component (2) and the collar component (1) are connected, the collar straps (3) and (4) can be connected behind the neck.

The central portion (5) of the collar component (1) can be made flat as shown in FIG. 5, for a clean, simple look. Alternatively, as shown in FIG. 6, the central portion (5) can have a piece of stuffing such as a foam or fabric sewn in place under the material to create the look of a knot, without the need to tie it.

When connected, the tie component (2) and collar component (1) create a tie that looks like a normal necktie, but without the need of tying a knot. The lower portion (7) at least of tie component (2) can be made in a variety of colors and patterns, as shown in FIGS. 7a-7c, and if the central portion (5) of the collar component (1) is made in a neutral color a single collar component (1) can be coordinated with many different tie components (2). A user could purchase several different color collar components (1), as well, to give a wide variety of mix-and-match possibilities.

FIGS. 3 and 4 show how the lower portion (7) of tie component (2) can have a variety of shapes within the teachings of the invention. In FIG. 3, the lower portion (7) has a straight line look hanging down from below the central portion (5) of the collar component (1). In FIG. 4, the lower portion (7) is formed with a narrow part adjacent the upper portion (6), with a curved part (10) leading downward to the rest of the tie component (2).

### Additional Ornamentation

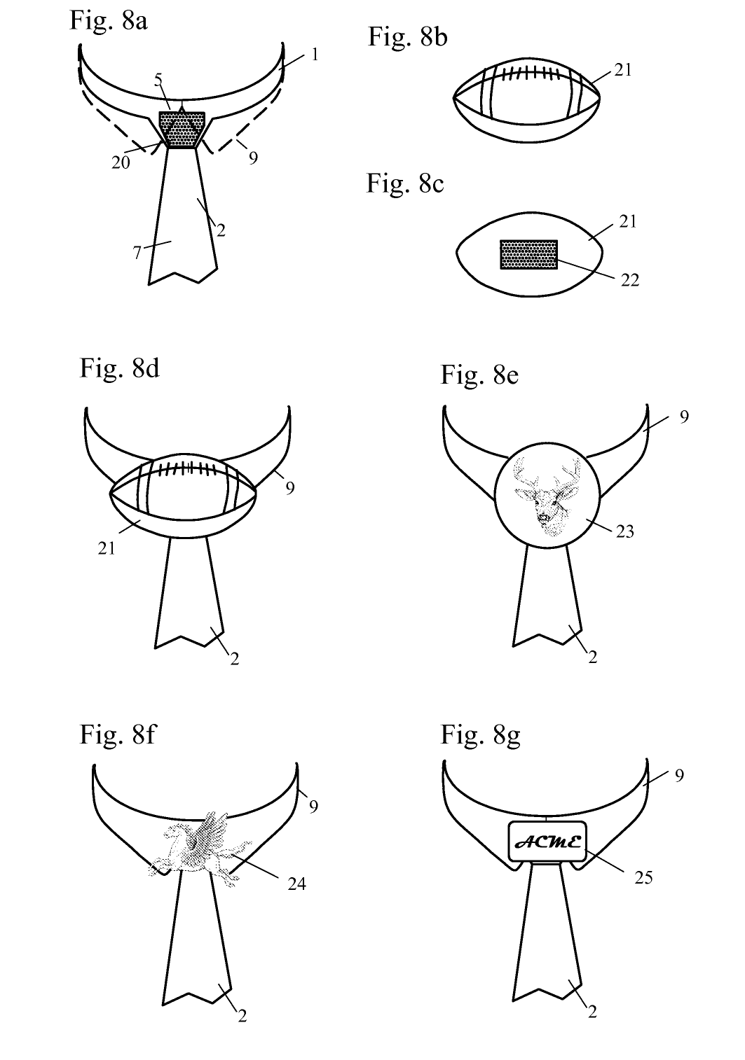

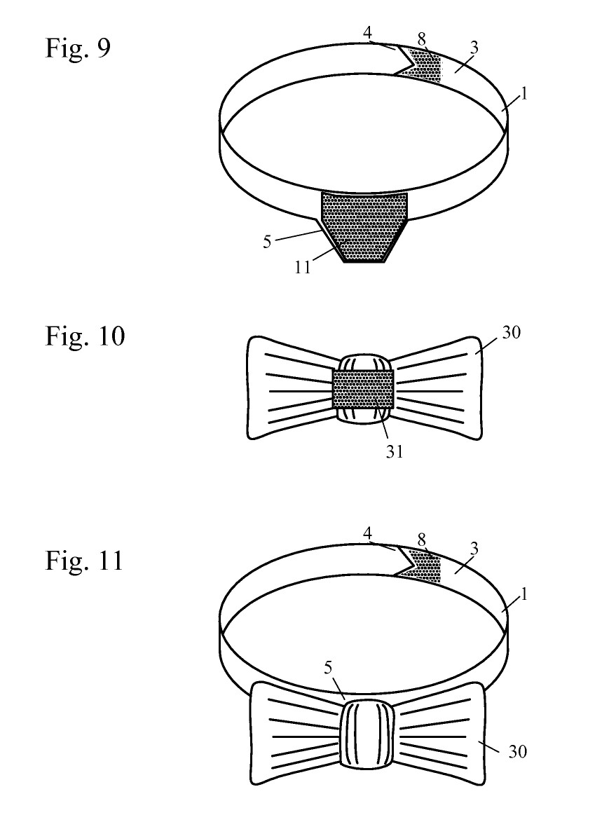

FIGS. 8a through 8g show how additional ornamentation can be incorporated into the necktie of the invention.

In FIG. 8a, an additional patch of fastener material (20) is added on the outside of central portion (5) of collar component (1), so that at least some of the material (20) is accessible between the shirt collar (9). An ornament, such as a football (21) in FIG. 8b, can be provided, with a mating patch of fastener material (22) on a rear surface as shown in FIG. 8c. This fastener can be hook-and-loop fastener material (8) such as Velcro®, or it will be evident to one skilled in the art that some other form of separable fastener material or a flat piece of magnetic material might be used. When the two pieces of fastener (20) and (21) are mated, as shown in FIG. 8d, the football (21) then forms an ornament outside the shirt collar (9) and above the tie component (2).

In similar fashion, other sports-oriented ornaments can be attached, such as a baseball, or a soccer ball or basketball, or a miniature football helmet, or other ornaments as might be desired. Alternatively, an ornament on a hunting theme, such as the deer head (23) as shown in FIG. 8e or a turkey or other animal, or an ornament representative of a hobby, membership in an organization, or other activity could be provided within the teachings of the invention.

The same approach can be used, as shown in FIG. 8f, to attach an item of jewelry (24), or, as shown in FIG. 8g, a name badge or company logo (25).

### Bowtie Embodiment

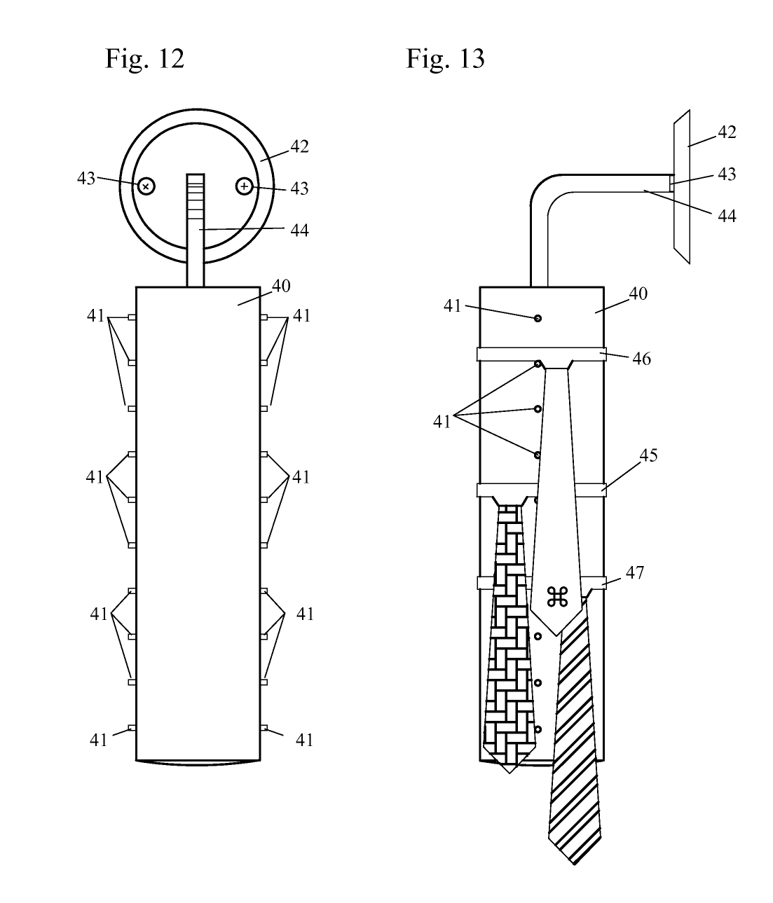

For additional versatility, as shown in FIGS. 9 through 11, the collar component (1) of the invention can be combined with a bowtie (30). In such an application, the collar component (1) can be reversed and worn with the fastener material (11) of the central portion (5) facing forward instead of backward. A mating piece of fastener material (31) on the rear of bowtie (30) can then be placed on fastener material (11) of the central portion (5) of the collar component (1), and a bowtie (30) can then replace the hanging tie component (2).

Alternatively, if the collar component (1) is formed with fastener material on both sides of the central portion (5) as noted above, the bowtie (30) could even be combined with the tie component (2) at the same time.

### The Necktie Holder

With the existing style ties, you don't need a certain type of holder, just a bar or a post to hang them on. The necktie of the invention can be stored on a cylindrical type of rotating holder because of the shape of the necktie.

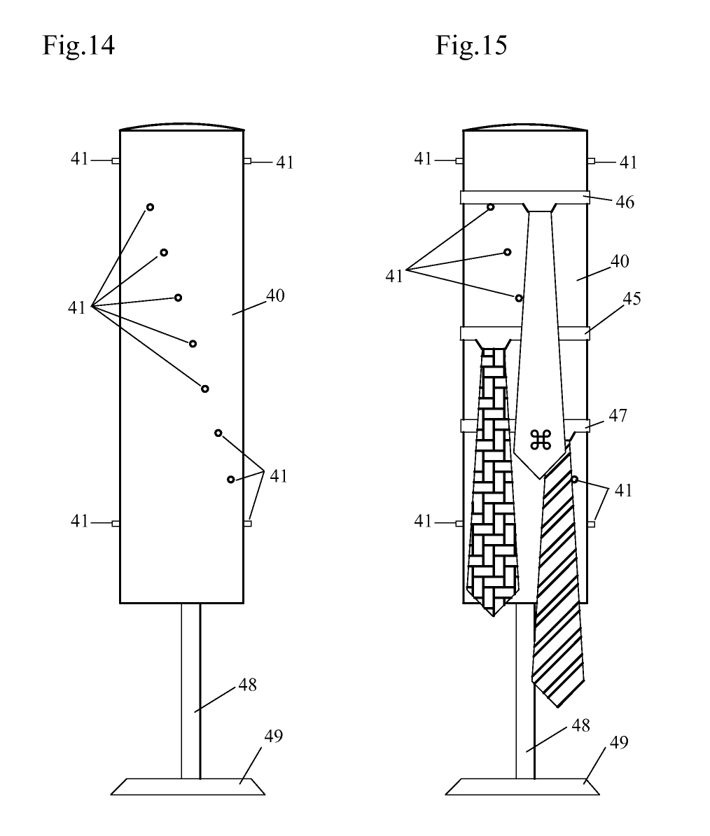

FIGS. 12 through 15 show a novel tie holder for use with the necktie of the invention, FIGS. 12 and 13 in an embodiment for the wall, and FIGS. 14 and 15 showing one that will stand on a horizontal surface such as a dresser or a table.

The holder comprises a cylindrical body (40) having a circumference similar to that of a neck. The holder can hang from a bracket (44) on a wall mount (42) which fastens to a wall or other vertical surface with screws (43) or similar fasteners. Alternatively, the cylindrical body (40) can be mounted upon a pipe (48) or other vertical support mounted up on a base (49).

Preferably, the coupling of the bracket (44) or pipe (48) and the body (40) will be any form of swivel which will allow the body (40) to rotate so a user can easily pick out the desired tie without fumbling through a pile of wrinkled ties.

A number of pegs (41) are mounted to or formed upon the surface of cylindrical body (40). At least one peg (41) per tie would be needed, however preferably at least two pegs (41) per tie are provided, arranged at intervals of 180° around a horizontal circumference of the cylinder as shown in the figures, which would reduce skewing of the tie which could occur if it were supported at only one point. Alternatively, even more pegs (41) could be provided—three pegs (41) at 120°, or four pegs (41) at 90°, etc. The pegs (41) can be arranged in a vertical row as shown in FIG. 13, or staggered in a spiral as shown in FIG. 15, or arranged in any other fashion desired. Preferably, the pegs are separated vertically by a distance which is at least as much as a height of the collar component (1) of the necktie of the invention.

When not in use, the neckties of the invention can be easily stored on the holder by wrapping collar portion (1) around the cylinder (40) and fastening the ends (3) and (4) as if they were around a neck. The neckties will be prevented from slipping down the cylinder (40) by the pegs (41). To remove a tie, a user simply peels apart the fasteners on the back of the collar component. The user may mix and match by removing any desired tie component (2) from its collar component (1) by separating the fasteners (11) and (12), and leaving the unused collar component (1) on the holder.

FIGS. 13 and 15 show three neckties (45), (46) and (47) on body (40). Preferably, the holder will have at least ten pegs (41) to hold at least ten neckties, as shown in the figures, although it will be appreciated that any number may be accommodated depending on the height of the cylindrical body.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A two part necktie comprising:
a) a collar component comprising:
i) an elongated body with a first end and a second end and a length therebetween sufficient to encircle a neck of a wearer
ii) a central portion along the length of the body between the first end and the second end, having a separable fastener material on at least one surface;
iii) a separable fastener on the first end; and
iv) a mating fastener on the second end, such that the body of the collar component can be fastened around a neck by mating the fastener of the first end and fastener of the second end;
b) a tie component comprising:
i) an upper portion having a separable fastener material on at least one surface; and
ii) an elongated lower portion forming a necktie;
the separable fastener material on at least one surface of the central portion of the body of the collar component and the separable fastener material on at least one surface of the upper portion of the tie component mating to fasten the tie component to the collar component, forming a necktie.

2. The necktie of claim 1 in which the separable fastener on the first end of the collar component and the mating fastener on the second end of the collar component are mating parts of hook-and-loop fastener material.

3. The necktie of claim 2, in which at least the first end of the collar component extends past the separable fastener, forming a tab to facilitate removal of the collar.

4. The necktie of claim 1 in which the separable fastener material on at least one surface of the central portion of the collar component and the separable fastener material on at least one surface of the upper portion of the tie component are mating parts of hook-and-loop fastener material.

5. The necktie of claim 1, in which the central portion of the collar component further comprises a second separable fastener material on an opposite side from the separable fastener material to which a tie component is fastened.

6. The necktie of claim 5, further comprising a removable ornament comprising a body having a separable fastener material on a rear side thereof for mating with the second separable fastener material of the central portion of the collar component.

7. The necktie of claim 1, further comprising a bowtie having a separable fastener material on a rear side thereof for mating with the separable fastener material of the central portion of the collar component.

8. The necktie of claim 1, in which the elongated lower portion of the tie component comprises a curved section in an area adjacent to the upper portion of the tie component.

9. The necktie of claim 1, in which the central portion of the collar portion further comprises a stuffing material.

10. The necktie of claim 9, in which the stuffing is foam.

11. A holder for a plurality of neckties, each comprising a collar component having an elongated body with a first end and a second end and a length therebetween, a central portion along the length of the body between the first end and the second end, having a separable fastener material on at least one surface and separable fasteners on the first end and the second end; and a tie component having a separable fastener material on at least one surface for mating with the separable fastener material on the central portion of the collar component to form a necktie; the holder comprising:
a) a cylindrical body having a circumference less than the length of the elongated body of the collar components of the plurality of neckties, and a height;
b) a plurality of pegs located along the height of the body, spaced apart along the height sufficient that a collar component of a necktie fits between adjacent pegs;
c) a support rotatably coupled to the cylindrical body;
such that a necktie can be supported on the holder by wrapping the elongated body around the circumference of the cylindrical body and fastening the fastener material on the first end and the second end, the collar portion being prevented from slipping down the cylindrical body by at least one peg.

12. The holder of claim 11 in which the support comprises a stand for supporting the holder on a horizontal surface.

13. The holder of claim 11 in which the support comprises a wall bracket.

14. The holder of claim 11, in which there are at least two pegs for each tie, arranged horizontally around a circumference of the cylindrical body.
